(19) United States
(12) Patent Application Publication
(10) Pub. No.: US 2023/0324198 A1
(43) Pub. Date: Oct. 12, 2023

(54) METHODS AND SYSTEMS FOR PROVIDING TRAILER GUIDANCE TO VEHICLE

(71) Applicant: GM GLOBAL TECHNOLOGY OPERATIONS LLC, Detroit, MI (US)

(72) Inventors: Akram Abdel-Rahman, Ajax (CA); Parastoo Baghaei, Toronto (CA); Shehbaz Hussain, Markham (CA)

(73) Assignee: GM GLOBAL TECHNOLOGY OPERATIONS LLC, Detroit, MI (US)

(21) Appl. No.: 17/658,876

(22) Filed: Apr. 12, 2022

(51) Int. Cl. G01C 21/36; G01C 21/34

(52) U.S. Cl. CPC G01C 21/3647; G01C 21/3492; G01C 21/3632

(57) ABSTRACT

Methods and systems are provided for providing guidance when reversing a vehicle towing a trailer. In one embodiment, a method includes: storing, in a data storage device, parameters associated with the vehicle and the trailer; when the vehicle towing the trailer is determined to be operating in reverse, receiving image data associated with an environment of the vehicle; computing, by a processor, an anticipated yaw rate of the trailer based on the parameters and steering angle data; determining, by the processor, at least one feature of at least one trailer guideline based on the anticipated hitch angle; and generating, by the processor, display data based on the image data and the at least one feature of the at least one trailer guideline.

### INTRODUCTION

The technical field generally relates to vehicles and, more specifically, to methods and systems for providing guidance to drivers of vehicles towing trailer while reversing the vehicle.

Autonomous, semi-autonomous and conventional vehicles can be designed to accommodate the towing or trailering of various loads that include without limitation: flatbeds, enclosed trailers, cargo hoppers, campers, boats, and sometimes other motorized vehicles. Also, a multitude of different trailer hitches can be used in the trailering operations such as gooseneck hitches, weight distribution hitches, pintle hitches, receiver hitches, and 5th wheel hitches. Each configuration of trailer type and hitch type presents different vehicle dynamics.

Reversing a trailer and having the trailer finish in a desired location can be a daunting task for many drivers. For example, understanding which direction the trailer will reverse towards based on the driver's steering and throttle input takes a lot of practice, especially in areas with little space. In addition, driver sight lines are often obstructed by the trailers, thereby requiring a second person external to the vehicle to obtain visual confirmation and provide feedback for the driver during a reversing operation.

Accordingly, it is desirable to provide methods and systems for providing guidance to drivers of vehicles towing trailer while reversing the vehicle. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for providing guidance when reversing a vehicle towing a trailer. In one embodiment, a method includes: storing, in a data storage device, parameters associated with the vehicle and the trailer; when the vehicle towing the trailer is determined to be operating in reverse, receiving image data associated with an environment of the vehicle; computing, by a processor, an anticipated yaw rate of the trailer based on the parameters and steering angle data; determining, by the processor, at least one feature of at least one trailer guideline based on the anticipated yaw rate; and generating, by the processor, display data based on the image data and the at least one feature of the at least one trailer guideline.

In various embodiments, the parameters include an effective length trailer, an effective length of the vehicle, and a distance from a hitch to a rear axle of the vehicle.

In various embodiments, the computing the anticipated yaw rate is further based on a vehicle speed.

In various embodiments, the at least one feature includes a direction of a curve or arrow.

In various embodiments, the at least one feature includes at least one of a color, a thickness, and a size of the at least one trailer guideline.

In various embodiments, the generating the display data includes overlaying the at least one trailer guideline on the image data.

In various embodiments, the generating the display data includes overlaying the at least one trailer guideline with the at least one feature.

In various embodiments, the method includes determining a display location within the image data, and the overlaying is based on the display location.

In various embodiments, the determining the display location is based on a predetermined location.

In various embodiments, the determining the display location is based on identified content within the image data.

In another embodiment, a system for providing guidance when reversing a vehicle towing a trailer is provided. The system includes: a computer readable medium configured to store parameters associated with the vehicle and the trailer; and a computer system onboard the vehicle and configured to, by a processor, and when the vehicle towing the trailer is determined to be operating in reverse: receive image data associated with an environment of the vehicle; compute an anticipated yaw rate of the trailer based on the parameters and steering angle data; determine at least one feature of at least one trailer guideline based on the anticipated yaw rate; and generate display data based on the image data and the at least one feature of the at least one trailer guideline.

In various embodiments, the parameters include an effective length trailer, an effective length of the vehicle, and a distance from a hitch to a rear axle of the vehicle.

In various embodiments, the computer system computes the anticipated yaw rate further based on a vehicle speed.

In various embodiments, the at least one feature includes a direction of a curve or arrow.

In various embodiments, the at least one feature includes at least one of a color, a thickness, and a size of the trailer guideline.

In various embodiments, the computer system generates the display data by overlaying the at least one trailer guideline on the image data.

In various embodiments, the computer system generates the display data by overlaying the at least one trailer guideline with the at least one feature.

In various embodiments, the computer system determines a display location within the image data, and overlays based on the display location.

In various embodiments, the display location is based on a predetermined location.

In various embodiments, the computer system determines the display location based on identified content within the image data.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a guidance system for providing guidance when the vehicle is towing a trailer, in accordance with various embodiments;

FIG. 2 is an interface illustrating elements presented by the guidance system in order to provide guidance, in accordance with various embodiments;

FIG. 3 is a dataflow diagram illustrating the guidance system of the vehicle of FIG. 1, in accordance with various embodiments;

FIG. 4 is a top-down view of the vehicle and the trailer illustrating various parameters used by the guidance system, in accordance with various embodiments; and

FIG. 5 is a flowchart of a process for providing guidance as performed by the guidance system of the vehicle of FIGS. 1 and 2, in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

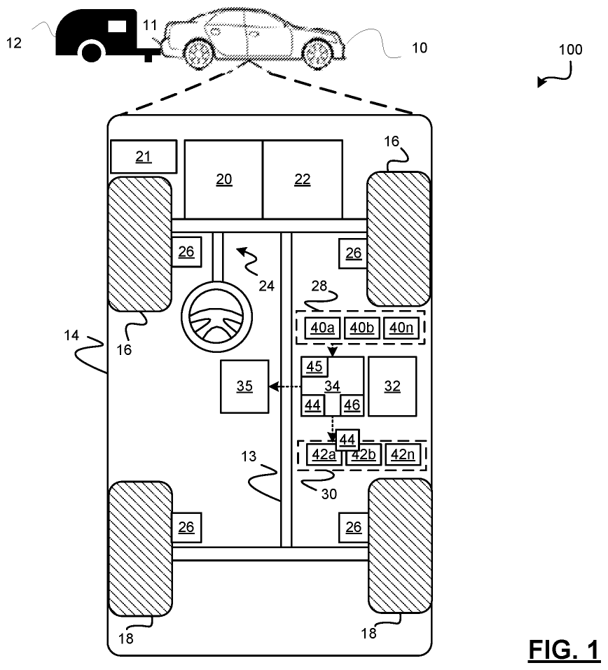

With reference to FIG. 1, a guidance system shown generally at 100 is associated with a vehicle 10 and a trailer 12 in accordance with various embodiments. As can be appreciated, the trailer 12 may any type of towable application having one or more wheels and is not limited to any one embodiment. The vehicle 10 is configured to couple to and connect to the trailer 12 via a connection apparatus 11 and is configured to tow the trailer 12. In various embodiments, the connection apparatus 11 comprises a hitch. In various other embodiments, the connection apparatus 11 comprises one or more other types of systems, such as a gooseneck for a fifth wheel trailer, and so on. In various embodiments, the connection apparatus 11 further comprises a wiring harness configured to communicate power and/or communication signals to and from components of the trailer 12. As described in greater detail further below, the guidance system 100 includes a computer system configured to assist drivers of the vehicle 10 with reversing the trailer 12 by dynamically displaying trailer guidelines on an image generated by a rear camera that senses an environment of the vehicle 10.

In various embodiments, the vehicle 10 comprises an automobile. The vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In various embodiments, the vehicle 10 may also comprise other types of mobile platforms capable of towing and is not limited to an automobile.

As depicted in FIG. 1, the exemplary vehicle 10 generally includes a chassis 13, a body 14, front wheels 16, and rear wheels 18. The body 14 is arranged on the chassis 13 and substantially encloses components of the vehicle 10. The body 14 and the chassis 13 may jointly form a frame. The wheels 16-18 are each rotationally coupled to the chassis 13 near a respective corner of the body 14.

The vehicle 10 generally includes a propulsion system 20, a transmission system 22, a steering system 24, a brake system 26, a sensor system 28, an actuator system 30, at least one data storage device 32, at least one controller 34, and a display system 35. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior and/or interior environment of the vehicle and/or of the vehicle itself. The sensing devices 40a-40n can include, but are not limited to, radars, lidars, global positioning systems, optical cameras, thermal cameras, ultrasonic sensors, inertial measurement units, pressure sensors, position sensors, speed sensors, and/or other sensors. In various embodiments, the sensor system 28 includes a camera 40a configured to sense an environment at or near a rear portion of the vehicle 10 and to generate image data based thereon.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in controlling the vehicle 10. In various embodiments, the data storage device 32 stores defined values for controlling the vehicle. As can be appreciated, the data storage device 32 may be part of the controller 34, separate from the controller 34, or part of the controller 34 and part of a separate system.

The controller 34 includes at least one processor 44, a communication bus 45, a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle and/or trailer. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

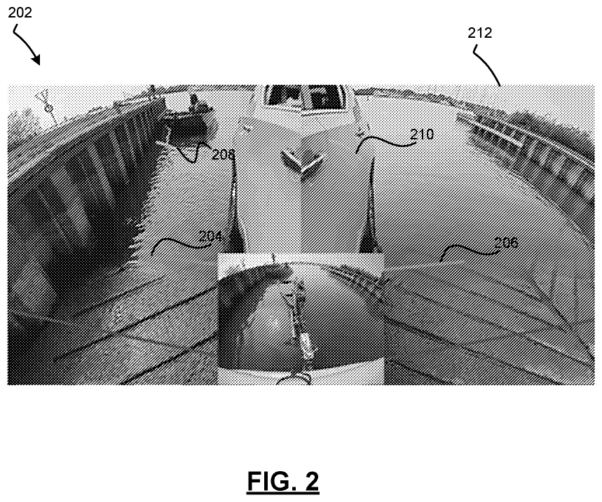

In various embodiments, one or more instructions of the controller 34 are embodied in the guidance system 100 and, when executed by the processor 44, receive data from the sensor system 28 and process the data in order to generate display data for display by the display system 35. In various embodiments, as shown in FIG. 2, the display data 200 includes image data 202 from the camera 40a as well as dynamically determined trailer guidelines 204, 206, 208, 210 presented as an overlay on the image data 202. The trailer guidelines 204, 206 include markings such as a straight line and/or curves having features such as color, thickness, appearance, etc. that illustrate the path the trailer 12 is following. The trailer guidelines 208, 210 include markings such as a curved arrow having features such as color, thickness, appearance, rate of display, etc. that illustrate an anticipated change in the hitch angle and the direction the trailer 12 would follow given the steering input and the vehicle velocity. The features (color, thickness, appearance, etc.) of the trailer guidelines 208, 210 are dynamically adjusted (e.g., color change, line thickness change, faster rate of display, etc.) to further illustrate the anticipated rate of change and direction of the trailer 12.

As can be appreciated, that the controller 34 and the image data 202 may otherwise differ from the embodiment depicted in FIGS. 1 and 2. For example, the controller 34 may be coupled to or may otherwise utilize one or more remote computer systems and/or other control systems, for example as part of one or more of the above-identified vehicle devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 34 may also otherwise differ from the embodiment depicted in FIG. 1, for example in that the computer system of the controller 34 may be coupled to or may otherwise utilize one or more remote computer systems and/or other control systems.

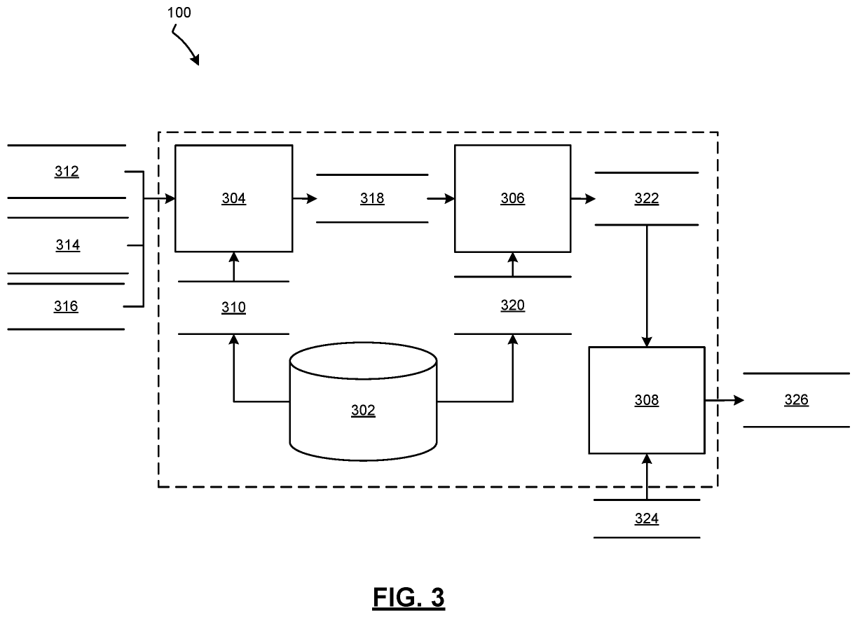

With reference to FIG. 3 and with continued reference to FIGS. 1 and 2, a dataflow diagram illustrates elements of the guidance system 100 of FIG. 1 in accordance with various embodiments. As can be appreciated, various embodiments of the guidance system 100 according to the present disclosure may include any number of modules embedded within the controller 34 which may be combined and/or further partitioned to similarly implement systems and methods described herein. Furthermore, inputs to the guidance system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like. In various embodiments, the guidance system 100 includes a parameter data datastore 302, a yaw rate determination module 304, a guideline determination module 306, and a display module 308.

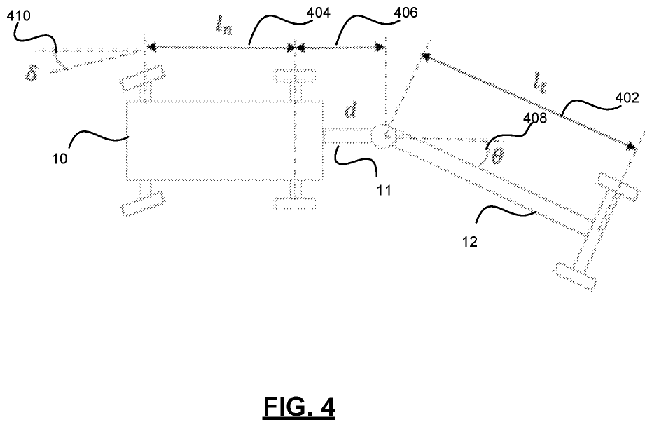

In various embodiments, the parameter data datastore 302 stores parameter data 310 associated with the vehicle 10 and/or the trailer 12. For example, as shown in the top-down illustration of FIG. 4, the parameter data datastore 302 stores as parameter data 310 including an effective length 402 of the trailer 12 lt, an effective length 404 of the vehicle 10 ln, and a distance 406 from the hitch 11 to a rear axle of the vehicle 10 d. The parameter data datastore 302 further stores maximum data 320 including a maximum hitch angle for reversing the trailer 12. As can be appreciated, the parameters 402, 404, 406 and the maximum data 320 can be defined and stored in the parameter data datastore 302 based on user input (e.g., a user interacting with a configuration interface), based on input from the trailer 12 (e.g., data communicated when the trailer 12 is communicatively coupled to the vehicle 10, and/or based on other means of storing defined values.

With reference back two FIG. 3, in various embodiments, the yaw rate determination module 304 receives as input vehicle data including steering angle data 312, vehicle speed data 314, and hitch angle data 316, as well as the parameter data 310. Based on the inputs, the yaw rate determination module 304 computes an anticipated yaw rate direction of the trailer 12. The yaw rate determination module 304 generates yaw rate data 318 based on the computed anticipated yaw rate direction.

For example, as illustrated in FIG. 4, the yaw rate determination module 304 determines the anticipated yaw rate based on the following relationships:

$$\dot{θ} = - \frac{{v}_{C}}{{l}_{t}} sin θ - \frac{{v}_{C}}{{l}_{n}} tan δ \times ( \frac{d}{{l}_{t}} cos θ + 1 ) , and$$

$$\dot{θ} = \frac{sin θ}{{l}_{t}} + \frac{1}{{l}_{n}} tan δ \times ( \frac{d}{{l}_{t}} cos θ + 1 ) ,$$

where \dot{θ} represents the anticipated change in hitch angle, θ represents the hitch angle 408, δ represents the road wheel angle 410, and V_{C} represents the speed of the vehicle 10 (i.e., which is assumed constant and in reverse).

With reference back to FIG. 3, in various embodiments, the guideline determination module 306 receives as input the yaw rate data 318, and the maximum hitch angle data 320. The guideline determination module 306 determines features of the trailer guidelines 208, 210 to be displayed and generates guideline data 322 based thereon. For example, the guideline determination module 306 determines a direction of an arrow or curvature of the trailer guidelines 208, 210 based on the value of the anticipated change in hitch angle 9. In another example, the guideline determination module 306 determines a size or thickness of the trailer guidelines 208, 210 based on the following relationship:

$$Arrow Size = 2 \times \frac{\dot{θ}}{Max ( \dot{θ} )} ,$$

where Max (\dot{θ}) represents the maximum hitch angle.

In various embodiments, the guideline determination module 306 determines the size and direction to be null when the value of the anticipated change in direction \dot{θ} is near zero. As can be appreciated, other features can be dynamically adjusted based on the computed anticipated change in hitch angle to help guide a driver of the vehicle 10 as embodiments are not limited to the present example.

In various embodiments, the display module 308 receives as input the image data 324, and the guideline data 322. The display module 308 generates display data 326 that includes the guideline data 322 overlayed on the image data 324, for example, as shown in FIG. 2. In various embodiments, the overlay location of the guideline data 322 can be predefined and/or determined based on the content of the image data (e.g., such that guidelines to do not obstruct the view of any particular object).

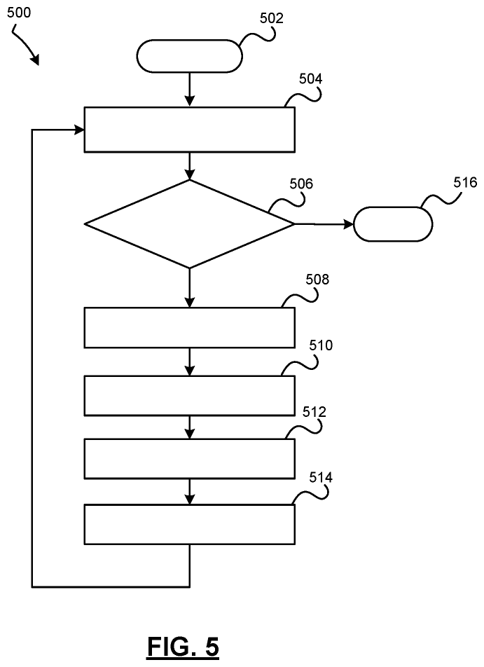

With reference now to FIG. 5 and with continued reference to FIGS. 1-4, a flowchart is provided of a method 500 for providing guidance for a vehicle 10 towing a trailer 12 as performed by the guidance system 100, in accordance with exemplary embodiments. As can be appreciated in light of the disclosure, the order of operation within the method 500 is not limited to the sequential execution as illustrated in FIG. 5, but may be performed in one or more varying orders as applicable and in accordance with the present disclosure. In various embodiments, the method 500 can be scheduled to run based on one or more predetermined events, and/or can run continuously during operation of the vehicle 10.

As can be appreciated, the various parameters are pre-stored in the parameter data datastore 302 while the vehicle 10 is not towing the trailer 12 or when the trailer 12 is first coupled to the vehicle 10.

In one example, the method 500 may begin at 502. The vehicle data, including the vehicle speed data, the steering angle data, and the hitch angle data, is received at 504. If the vehicle 10 is operating in reverse at 506, the anticipated yaw rate is determined based on the received data, for example, using the relationships discussed above at 508. The guidance data is determined including the size and the direction of the guidance arrow at 510. The guidance data is then overlayed on the image data at 512 and the image data is used to display the guidance arrows to the user in a meaningful way at 514. Thereafter, the method 500 continues while the vehicle 10 is operating in reverse. Once the vehicle is placed in park or some other range, the method 500 may end at 516.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for providing guidance when reversing a vehicle towing a trailer, comprising:
storing, in a data storage device, parameters associated with the vehicle and the trailer;
when the vehicle towing the trailer is determined to be operating in reverse, receiving image data associated with an environment of the vehicle;
computing, by a processor, an anticipated yaw rate of the trailer based on the parameters and steering angle data;
determining, by the processor, at least one feature of at least one trailer guideline based on the anticipated yaw rate; and
generating, by the processor, display data based on the image data and the at least one feature of the at least one trailer guideline.

2. The method of claim 1, wherein the parameters include an effective length trailer, an effective length of the vehicle, and a distance from a hitch to a rear axle of the vehicle.

3. The method of claim 1, wherein the computing the anticipated yaw rate is further based on a vehicle speed.

4. The method of claim 1, wherein the at least one feature includes a direction of a curve or arrow.

5. The method of claim 1, wherein the at least one feature includes at least one of a color, a thickness, and a size of the at least one trailer guideline.

6. The method of claim 1, wherein the generating the display data comprises overlaying the at least one trailer guideline on the image data.

7. The method of claim 6, wherein the generating the display data comprises overlaying the at least on trailer guideline with the at least one feature.

8. The method of claim 6, further comprising determining a display location within the image data, and wherein the overlaying is based on the display location.

9. The method of claim 8, wherein the determining the display location is based on a predetermined location.

10. The method of claim 8, wherein the determining the display location is based on identified content within the image data.

11. A system for providing guidance when reversing a vehicle towing a trailer, comprising:
a computer readable medium configured to store parameters associated with the vehicle and the trailer; and
a computer system onboard the vehicle and configured to, by a processor, and when the vehicle towing the trailer is determined to be operating in reverse:
receive image data associated with an environment of the vehicle;
compute an anticipated yaw rate of the trailer based on the parameters and steering angle data;
determine at least one feature of at least one trailer guideline based on the anticipated yaw rate; and
generate display data based on the image data and the at least one feature of the at least one trailer guideline.

12. The system of claim 11, wherein the parameters include an effective length trailer, an effective length of the vehicle, and a distance from a hitch to a rear axle of the vehicle.

13. The system of claim 11, wherein the computer system computes the anticipated yaw rate further based on a vehicle speed.

14. The system of claim 11, wherein the at least one feature includes a direction of a curve or arrow.

15. The system of claim 11, wherein the at least one feature includes at least one of a color, a thickness, and a size of the at least one trailer guideline.

16. The system of claim 11, wherein the computer system generates the display data by overlaying the at least one trailer guideline on the image data.

17. The system of claim 16, wherein the computer system generates the display data by overlaying the at least one trailer guideline with the at least one feature.

18. The system of claim 16, wherein the computer system determines a display location within the image data, and overlays based on the display location.

19. The system of claim 18, wherein the computer system determines the display location based on a predetermined location.

20. The system of claim 18, wherein the computer system determines the display location based on identified content within the image data.
